(19) United States
(12) Patent Application Publication
(10) Pub. No.: US 2009/0038106 A1
(43) Pub. Date: Feb. 12, 2009

(54) Engine blower

(75) Inventors: Shinichi Wada, Kawagoe-shi (JP); Ryouji Zama, Kawagoe-shi (JP); Koue Miyazawa, Kawagoe-shi (JP); Junichi Yoshino, Kawagoe-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: ZENOAH CO., LTD., Kawagoe-shi (JP)

(21) Appl. No.: 11/891,565

(22) Filed: Aug. 10, 2007

(51) Int. Cl. E01H 1/08; F02B 63/02

(52) U.S. Cl. 15/326

(57) ABSTRACT

An engine blower includes a muffler (9) provided to an engine and a volute case (31) accommodating a fan driven by the engine. On a muffler main body (10) of the muffler (9), an exhaust-gas guide member (21) covering an exhaust-gas outlet port and a cover hood (22) covering the exhaust-gas guide member (21) on the side of the outlet port are provided. Between the exhaust-gas guide member (21) and the cover hood (22), an outside-air introduction gap (23) is formed, through which outside air is introduced into the cover hood (22) by ejector effects. A blow-off port (32) for blowing off a part of pressure air in the volute case (31) to the outside-air introduction port (23) is only provided at a position substantially on a back side of the outside-air introduction gap (23).

### BACKGROUND OF THE INVENTION

1. Field of the Invention

The present invention relates to an engine blower, specifically to an improvement in a cooling structure for exhaust gas exhausted from an engine.

2. Description of Related Art

Engine blowers for blowing and collecting fallen leaves as well as pruned branches and leaves have been known. Such engine blower is carried by an operator in use and may be subject to regulations in terms of a temperature of exhaust gas from a muffler for eco-friendliness. Low-temperature discharge has been requested for the engine blower.

To lower the exhaust gas temperature, air may be taken in from outside to be mixed with the exhaust by jet flow of the exhaust gas. Specifically, an exhaust-gas guide member for discharging exhaust gas from a muffler main body in a predetermined direction is provided on a surface of the muffler main body. The exhaust-gas guide member is covered by a cover hood. Owing to ejector effects by the exhaust gas discharged from the exhaust-gas guide member, outside air is introduced into the cover hood to be mixed with the exhaust gas to lower the exhaust gas temperature.

In addition to the above-mentioned method for lowering the exhaust gas temperature by the ejector effects, the exhaust gas temperature can be further lowered by efficiently cooling a surface of the muffler (Japanese Patent No. 3594810). Specifically, a plurality of blow-off ports are formed on a volute case for accommodating a fan of the engine blower at positions around an outer circumference of the muffler and a part of pressure air generated by rotation of the fan is blown off as cooling air from the blow-off ports toward the muffler.

According to the technique disclosed in Japanese Patent No. 3594810, since the surface of the muffler is cooled by the cooling air from the blow-off ports, exhaust gas flowing along an inner surface of the muffler can be effectively cooled. However, the rest of the exhaust gas will not be sufficiently cooled, so that the exhaust gas temperature cannot be effectively lowered. Further, since the cooling air is initially blown to the entire muffler, the cooling air temperature increases. Hence, when the temperature-raised cooling air is mixed with the exhaust gas by the ejector effects, the exhaust gas temperature may not be sufficiently lowered.

### SUMMARY OF THE INVENTION

An object of the present invention is to provide an engine blower that can reliably lower a temperature of exhaust gas.

An engine blower according to an aspect of the invention includes: a muffler provided to an engine and a volute case accommodating a fan driven by the engine. On a muffler main body of the muffler, an exhaust-gas guide member covering an exhaust-gas outlet port and a cover hood covering the exhaust-gas guide member on the side of the outlet port are provided. Between the exhaust-gas guide member and the cover hood, an outside-air introduction gap is formed, through which outside air is introduced into the cover hood by ejector effects. A blow-off port for blowing off a part of pressure air in the volute case to the outside-air introduction port is only provided at a position substantially on a back side of the outside-air introduction gap.

The description of “a position substantially on a back side” means a position on a back side when seeing in a direction in which the exhaust gas is exhausted, so that a position slightly displaced from the position just at the back of the outside-air introduction gap is also included in the description as long as the displaced position is within the range in which the pressure air from the blow-off port directly flows to the outside-air introduction gap.

According to the aspect of the invention, since only the cooling air from the blow-off port provided substantially on the back side is taken into the outside-air introduction gap provided to enhance the ejector effects, a large amount of cooling air can be introduced into the cover hood from the outside-air introduction gap. Hence, the exhaust gas can be effectively mixed with the large amount of cooling air of a low temperature, so that the exhaust gas temperature can be greatly lowered.

In the engine blower of the invention, the blow-off port may be provided on an end of a guide portion extending from the side of an opening on the volute case toward the outside-air introduction gap.

According to the aspect of the invention, since the blow-off port is provided on the end of the guide portion, the guide portion can reliably guide the cooling air from the blown-off port to the outside-air introduction gap, so that an increased amount of air can be introduced into the cover hood to further enhance the ejector effects, thereby further promoting the reduction in the exhaust gas temperature.

### BRIEF DESCRIPTION OF THE DRAWINGS

FIG. 1 is a partially-exploded perspective view showing an entire engine blower according to an embodiment of the invention;

FIG. 2 is a perspective view showing an entire muffler according to the embodiment;

FIG. 3 is a partially-cross-sectional side view showing a primary portion according to the embodiment; and

FIG. 4 is a side view showing a modification of the invention.

### DETAILED DESCRIPTION OF PREFERRED EMBODIMENT(S)

An embodiment of the present invention will be described below with reference to the drawings.

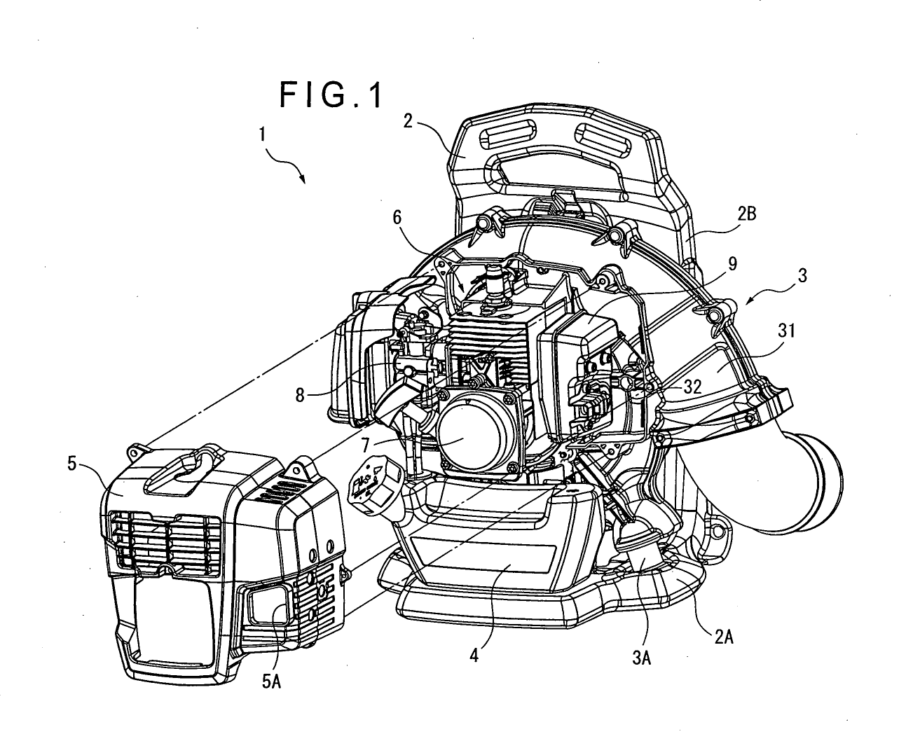

FIG. 1 is a partially-exploded perspective view of an entire engine blower 1 according to the embodiment.

In FIG. 1, the engine blower 1 includes an L-shaped frame 2 made of synthetic resin having a horizontal mounting portion 2A and a vertical back support 2B. A blower 3 is mounted on the mounting portion 2A of the frame 2 via a rubber mount 3A and supported at two positions on the right and left (only one of which is illustrated in FIG. 1). The blower 3 is also connected to the back support 2B via a connecting member (not shown).

A fuel tank 4 is also mounted on the mounting portion 2A, from which fuel is supplied to an engine 6 attached in front of a volute case 31 of the blower 3. The engine 6 rotates a fan (not shown) accommodated in the volute case 31. Pressure air generated by the rotation of the fan is ejected from a nozzle provided at an end of an air pipe connected to the volute case 31.

The engine 6 is started by a cranking operation on a recoil starter 7. The engine 6 includes: a carburetor 8 that produces air-fuel mixture of the fuel from the fuel tank 4 and suction air; and a muffler 9 that exhausts exhaust gas while deadening engine sound. The engine 6 is generally covered by an engine cover 5 screwed to the volute case 31.

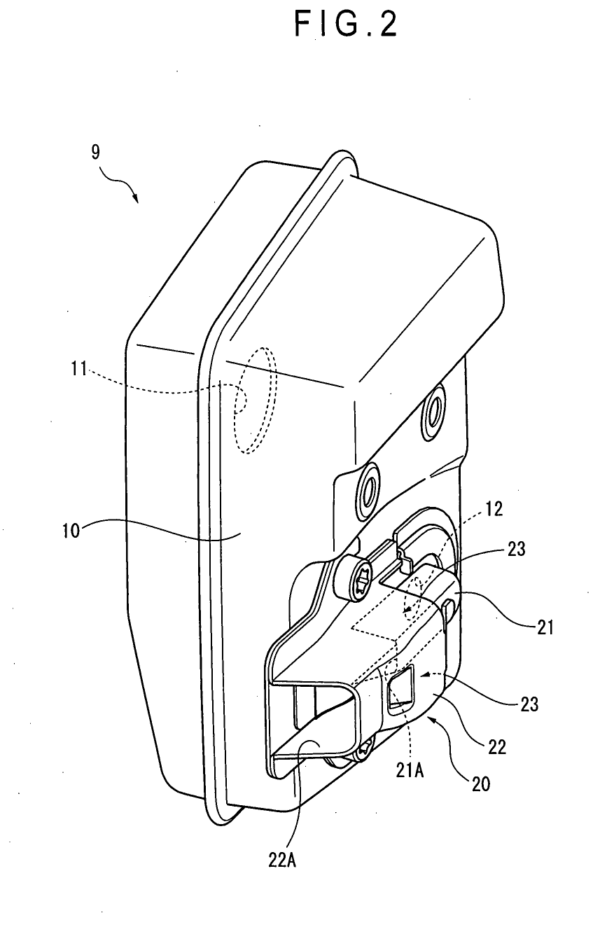

As shown in FIG. 2, the muffler 9 of the engine 6 includes: a box-like muffler main body 10 in which an expansion chamber is provided; and an attachment 20 attached on a side of the muffler main body 10. Exhaust gas introduced into the expansion chamber through an intake port 11 formed on a rear side of the muffler main body 10 (a side on which the muffler main body 10 is attached to the engine 6) is discharged through an outlet port 12 and the attachment 20 covering the outlet port 12 which are on a front side of the muffler main body 10.

The attachment 20 has an integrated arrangement of: an exhaust-gas guide member 21 corresponding to the outlet port 12 of the muffler main body 10; and a cover hood 22 covering the exhaust-gas guide member 21. Specifically, the cover hood 22 covers an exhaust port 21A of the exhaust-gas guide member 21. Between the cover hood 22 and the exhaust-gas guide member 21, an outside-air introduction gap 23 for introducing outside air into the cover hood 22 by an ejector.

When exhaust gas from the outlet port 12 of the muffler main body 10 is swiftly ejected from the exhaust port 21A after being directed by the exhaust-gas guide member 21, the momentum of the exhaust gas causes outside air to be introduced through the outside-air introduction gap 23 into the cover hood 22 where the outside air is mixed with the exhaust gas to lower a temperature of the exhaust gas. The exhaust gas of which temperature has been lowered after being mixed with the outside air is exhausted through the exhaust port 22A of the cover hood 22 and an opening 5A of the engine cover 5 to the outside.

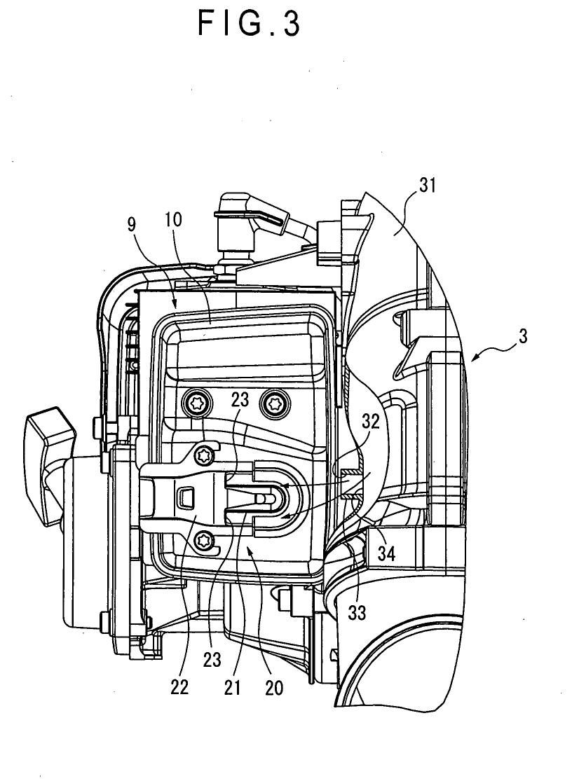

The most characteristic arrangement of the embodiment will be described below with reference to FIG. 3. A blow-off port 32 is provided in the volute case 31 only at a position substantially on a back side of the outside-air introduction gap 23 formed in the attachment 20 (a back side in the gas-exhausting direction). There is only one blow-off port 32 on the volute case 31 and no other blow-off port 32 is provided. From the blow-off port 32, a part of the pressure air in the volute case 31 is blown off as cooling air from the blow-off port 32 substantially directly into the outside-air introduction gap 23.

The blow-off port 32 is provided on an end of a cylindrical guide portion 33 projecting toward the attachment 20 from the circumference of an opening 34 of the volute case 31. The guide portion 33 also guides the cooling air blown off from the blow-off port 32 in a suitable manner such that the cooling air is reliably introduced into the outside-air introduction opening.

Specifically, in the embodiment, the cooling air blown off from the blow-off port 32 is exclusively and proactively introduced into the outside-air introduction gap 23 in order to promote the ejector effects without being consumed to cool an outer surface of the muffler main body 10. As a result, the exhaust gas is mixed with a large amount of outside air, so that the temperature of the exhaust gas can be greatly lowered.

Note that the best arrangement, process and the like for implementing the present invention have been disclosed in the above description but the scope of the invention is not limited thereto. In other words, although the invention is particularly illustrated and described in the specific embodiment, the skilled person in the art can modify the above-described shapes, quantities and other details without departing from the technical idea and the scope of the invention.

Hence, the above-disclosed description limiting the shapes, quantities and the like is given only to facilitate the understanding of the invention but not to limit the invention. Accordingly, description using the names of components without a part of or all of the limitation on the shapes, quantities and the like is also included in the scope of the invention.

For example, although the blow-off port 32 is provided on the end of the guide portion 33 in the above-described embodiment, the blow-off port 32 can be formed directly in the volute case 31. Specifically, even when no guide portion 33 is provided and the blow-off port 32 practically works as the opening 34, the outside air for cooling can be proactively introduced into the cover hood 22 from the outside-air introduction gap 23 since the blow-off port 32 is positioned substantially at the back side of the outside-air introduction gap 23. Hence, the temperature of the exhaust air can be effectively lowered owing to a large amount of introduced outside air. However, the exhaust air can be more effectively cooled when the guide portion 33 is provided because the cooling air is unlikely to be scattered.

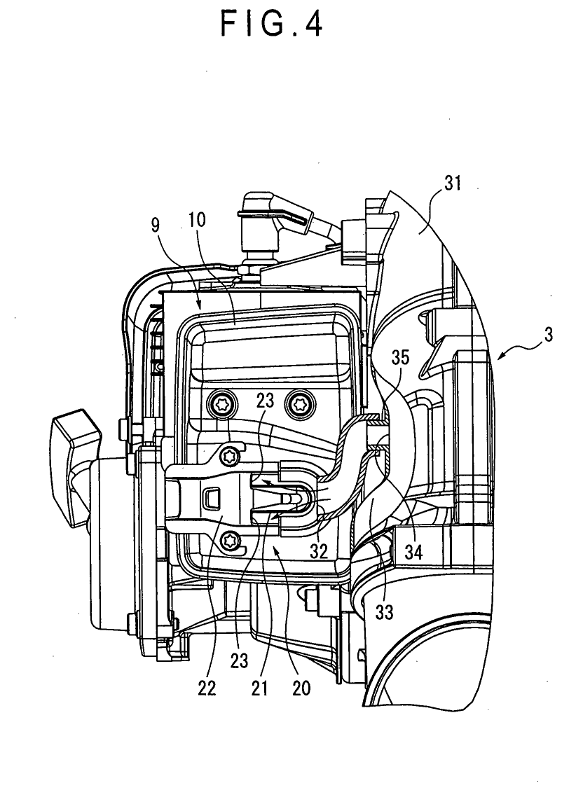

Additionally, an arrangement shown in FIG. 4 is also included in the scope of the invention.

In FIG. 4, the opening 34 is formed in the volute case 31 at a position displaced toward the upper side from the position on the back side of the outside-air introduction gap 23. A cylindrical projection 35 is provided around the circumference of the opening 34. The tubular guide portion 33 is attached to the projection 35. The guide portion 33 is curved in a suitable shape. The blow-off port 32 is provided on an end of the guide portion 33 just at the back side of the outside-air introduction gap 23.

Since the guide portion 33 extends in the vicinity of the muffler main body 10, the guide portion 33 is easily affected by heat from the muffler main body 10. Hence, the guide portion 33 is made as a separate component from the volute case 31 with more heat-resistant material. In the arrangement, since the volute case 31 uses the guide portion 33 as a body separate from the volute case 31, the opening 34 can be located at any position, thereby enhancing flexibility in design.

Note that the separately-provided guide portion 33 may be made of metal and integrally provided with the muffler main body 10 and the attachment 20. In the arrangement, when a base side of the guide portion 33 is directly attached to the projection 35, the projection 35 may be thermally deformed. Hence, the guide portion 33 and the projection 35 may be insulated by, for instance, providing a small gap therebetween.

Further, the invention has a feature that the blow-off port is provided only at a position on the substantially back side of the outside-air introduction gap, where an arrangement provided with a plurality of blow-off ports around the position on the substantially back side of the outside-air introduction gap is also included in the scope of the invention.

The Japanese application Number JP2006-211867 upon which this patent application is based is hereby incorporated by reference.

What is claimed is:

1. An engine blower, comprising:
a muffler provided to an engine and having a muffler main body and an outlet port for exhaust gas;
a volute case accommodating a fan driven by the engine;
an exhaust-gas guide member provided on the muffler main body and covering the outlet port;
a cover hood provided on the muffler main body and covering the exhaust-gas guide member on the side of the outlet port;
an outside-air introduction gap formed between the exhaust-gas guide member and the cover hood, through which outside air can be introduced into the cover hood by ejector effects; and
a blow-off port provided at a position substantially at a back side of the outside-air introduction gap, from which a part of pressure air in the volute case is blow off to the outside-air introduction port.

2. The engine blower according to claim 1, wherein
the blow-off port is provided on an end of a guide portion extending from the side of an opening on the volute case toward the outside-air introduction gap.
